(19) United States
(12) Patent Application Publication
(10) Pub. No.: US 2007/0158461 A1
(43) Pub. Date: Jul. 12, 2007

(54) Bottle for dispersing two liquids

(75) Inventors: Shaun Patrick Rymer, Hull (GB); Jacobus Simon Petrus Van Diepen, Ladenburg (DE)

Correspondence Address: NORRIS, MCLAUGHLIN & MARCUS, 875 THIRD AVE, 18TH FLOOR, NEW YORK, NY, 10022, US

(73) Assignee: Reckitt Benckiser (UK) Limited, Slough (GB)

(21) Appl. No.: 10/565,893

(22) PCT Filed: Jun. 17, 2004
(86) PCT No.: PCT/GB04/02586

§ 371 Date: Sep. 22, 2006

(30) Foreign Application Priority Data
Jul. 29, 2003 (GB) 0317720.1

(51) Int. Cl. A62C 13/62; A62C 13/66

(52) U.S. Cl. 239/302; 239/303; 239/304

(57) ABSTRACT

A bottle for dispensing two liquids, the bottle comprising two reservoirs, one for each liquid, a nozzle through which the liquids are dispensed from the bottle, a passageway from each reservoir leading out of the nozzle, and a deflector plate between the two passageways and projecting from the end of a nozzle in a direction substantially parallel to the direction of flow from the nozzles thereby causing the liquid leaving one passageway to be deflected towards the liquid leaving the other passageway so that the two liquids first mix once they have passed the deflector plate.

The present invention relates to a bottle for dispensing two liquids which are mixed on dispensing.

The invention has a particular application to dispensing a liquid detergent for example underneath the rim of a toilet bowl. However, the invention can be applicable to any situation where two liquids are required to be stored separately and are then mixed on dispensing.

Currently, detergents for use under the rim of a toilet bowl are one part detergents. There is some benefit, however, in providing a two part detergent which is mixed on dispensing. For example, the two parts may be a bleach and an enzyme which, when combined, would lead to degradation of the enzyme before it could be used. Alternatively, the two parts may be combined to produce a foam effect. As a further alternative, the two parts may be of different colours and may be arranged to interact to provide a third colour. The difficulty with such an arrangement is to provide a combined flow of the two liquids which is both well mixed and stable in the sense that there is no downstream separation of the two flows, so that the mixed flow can be precisely directed.

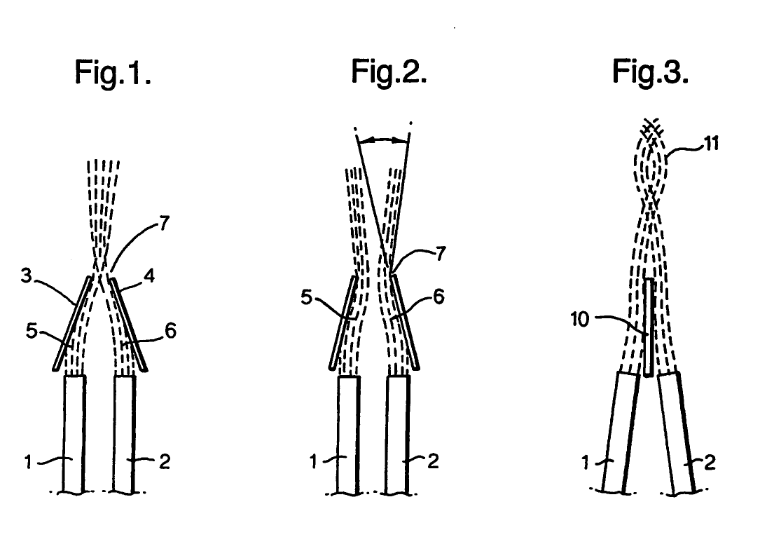

One way in which we have attempted to overcome this problem is to provide a convergent nozzle as shown schematically in FIGS. 1 and 2. In these Figures, the nozzle is represented by a pair of passageways 1,2 and a pair of converging deflector plates 3,4 from which two jets 5,6 of liquid are ejected through an exit 7. For a wider exit 7 as shown in FIG. 2 the two flows actually tended to diverge. However, when the exit was narrowed to the extent shown in FIG. 1, the two jets 5,6 were caused to touch, but the flow was unstable and direction control was poor.

According to the present invention there is provided a bottle for dispensing two liquids, the bottle comprising two reservoirs, one for each liquid, a nozzle through which the liquids are dispensed from the bottle, a passageway from each reservoir leading out of the nozzle, and a deflector plate between the two passageways and projecting from the end of a nozzle in a direction substantially parallel to the direction of flow from the nozzles thereby causing the liquid leaving one passageway to be deflected towards liquid leaving the other passageway so that the two liquids first mix once they have passed the deflector plate.

Such an arrangement has been found to provide reliable mixing of the two jets resulting in a combined jet with very good directional flow.

The invention is based on the wall attachment or Coanda effect. As the deflector plate projects beyond the nozzle, the two liquids travel along this wall for a short time after they are free of the rest of the nozzle. The wall attachment or Coanda effect causes each jet to be deflected towards the other jet as it leaves the deflector plate thereby forming a mixed flow.

One or more further liquids may be dispensed from one or more additional reservoirs. These additional liquids may also be provided with a deflector plate.

The passageways may be concentric, in which case the wall defining the inner passageway projects beyond that of the outer passageway. The liquid from the outer passageway will therefore travel along the wall of the inner passageway after it has left the outer passageway and will hence tend to be deflected inwardly towards the liquid emerging from the inner passageway. However, preferably, the two passageways are arranged in a side-by-side relationship. The passageways may either be adjacent to one another with a single deflector plate deflecting the liquid from both passageways. Alternatively, the passageways may be spaced apart with each passageway being provided with its own deflector plate or, indeed, only one of the two passageways being provided with a deflector plate. A spaced apart arrangement reduces the possibility of suck back of liquid from one reservoir into the other.

It has been found that the deflecting effect is enhanced if the free end of the deflector plate is inwardly tapered in the direction of flow.

The two passageways in the nozzle may themselves be convergent. However, preferably, the passageways are substantially parallel as this provides improved mixing.

As the bottle is primarily designed for use in a detergent, the nozzle is preferably angled with respect to a main axis of the bottle which will allow the jet to be directed underneath the rim of a toilet bowl.

The viscosity of the two liquids should preferably similar to ensure equal discharge of the liquid. However, if the viscosities are significantly different, it may possible to compensate for this by making one of the nozzles larger. Preferably, the viscosity of each liquid is less than 1000 Cps and more preferably less than 500 Cps. Suitable liquids include standard bleach (which has a viscosity of around 500 Cps) and Harpic (RTM) limescale which has a viscosity of around 380 Cps. Liquids having a viscosity similar to that of water (1 Cps) are suitable for use in this way.

The two liquids are preferably liquids which are mixed to form a detergent. Such a detergent may, for example, be used in fabric care, dishwashing, hard surface cleaning (including drain cleaning and lavatory cleaning) and bleaching/stain removing applications.

The invention also extends to a nozzle through which two liquids are dispensed, the nozzle being provided with two passageways and a deflector plate in the nozzle between the two passageways and projecting from the end of the nozzle thereby causing at least one of the liquids leaving the passageways to be deflected towards the other so that the two liquids first mix once they have passed the deflector plate. Such a nozzle is suitable for use within the bottle referred to above.

Examples of the present invention will now be described with reference to the accompanying drawings, in which:

FIGS. 1 and 2 are schematic drawings showing prior art arrangements;

FIG. 3 is a schematic drawing similar to FIGS. 1 and 2 showing the principle of the present invention;

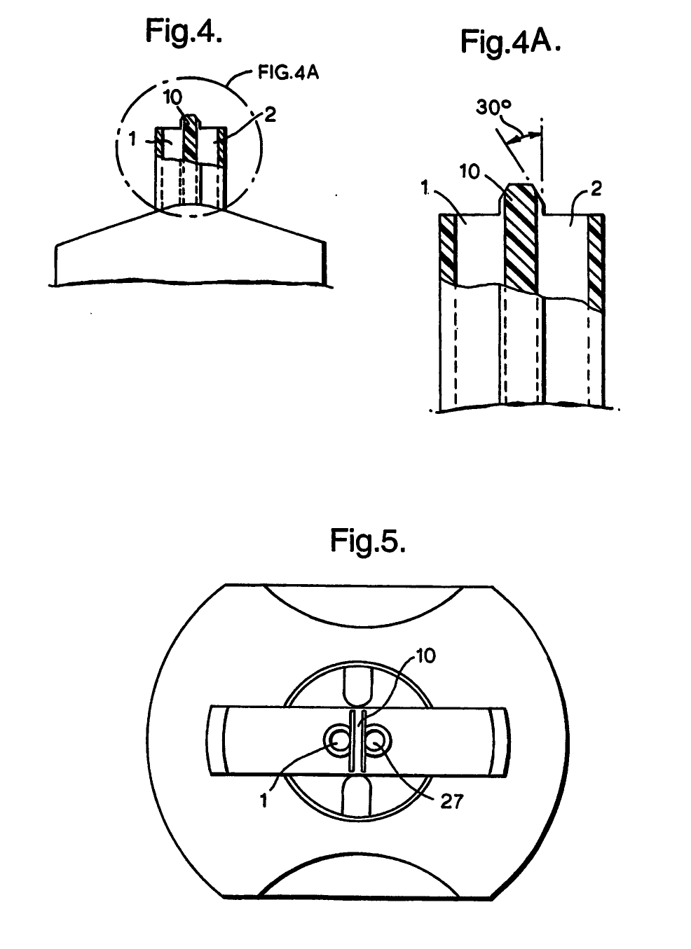

FIG. 4 is a schematic view of the top of a bottle showing the nozzle partially in cross section;

FIG. 4A shows a detail from FIG. 4;

FIG. 5 is a plan view of the nozzle;

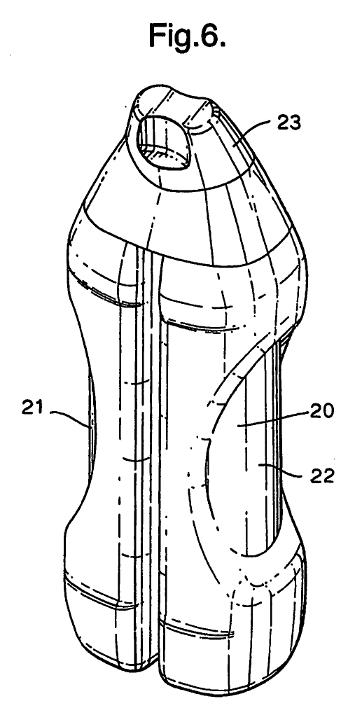

FIG. 6 is a perspective view of a bottle in accordance with the present invention;

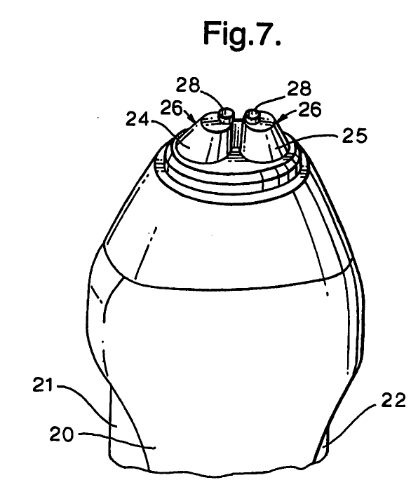

FIG. 7 shows the top of the bottle of FIGS. 6 with the cap removed;

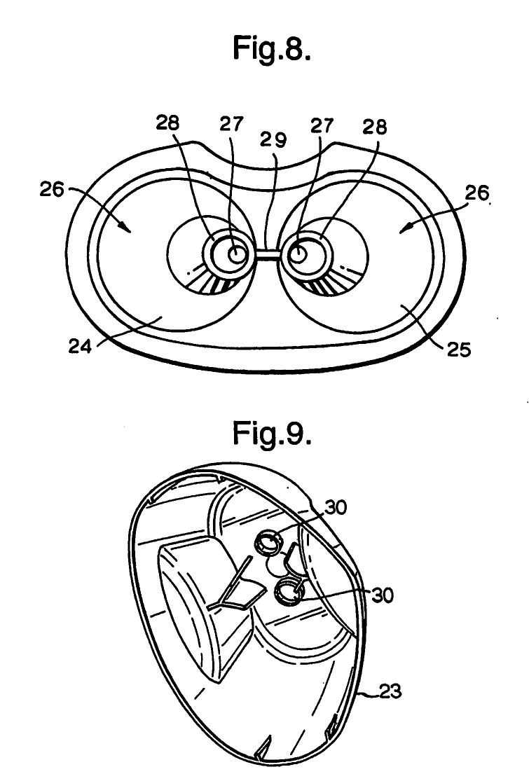

FIG. 8 is a plan view of the top of the bottle as shown in FIG. 7; and

FIG. 9 is a perspective view showing the inside of the cap of the bottle of FIG. 6.

The principle behind the invention is illustrated in FIG. 3. Liquid flows from two passageways 1,2 as two jets 5,6. The two jets then flow along opposite sides of deflector plate 10. As the two flows pass the end of the deflector plate, the wall attachment or Coanda effect causes a slight deflection of each jet towards the deflector plate 10. As shown in FIG. 3, the two flows are generally parallel and are deflected gently towards one another readily forming a stable mixed flow 11. It has been found that the two jets tend to combine with a twisting motion as shown in FIG. 3. This promotes mixing of the two jets.

A more detailed view of the nozzle is shown in FIGS. 4, 4A and 5. A nozzle 12 is provided on the neck of a bottle 13. In practice, the nozzle will be offset at an angle to a main axis of the bottle to allow the dispensed jet to be directed underneath the rim of a toilet bowl. The nozzle comprises two parallel passageways 1,2 each linked with a separate reservoir compartment (not shown) within the bottle 13. Between the two nozzles 1,2 is a deflector plate 10. As shown in the FIGS. 4, 4A and 5, the passageways 1,2 are recessed slightly into the deflector plate 10 itself. The plate extends in a plane parallel to the direction of flow from the passageways 1,2 and is perpendicular to a line joining the centres of the two passageways 1,2. The plate projects a short distance beyond the end of passageways 1,2. The top of the deflector plate 10 is chamfered on both sides to promote the deflection of the liquid.

Although not shown in the drawings, the nozzle will be closed by a flip up cap. The cap will be provided with a pair of depending pins to seal the two passageways 1,2.

A bottle in accordance with the present invention is shown in FIGS. 6 to 9. The bottle 20 is split into two separate reservoirs 21, 22. The bottle is closed by a cap 23. Each of the reservoirs 21, 22 discharges through a respective nozzle 24, 25 as best shown in FIGS. 7 and 8. Each nozzle, 24, 25 has a housing portion with an outer wall 26 which is inwardly tapered in the direction of flow to provide a gradually narrowing passage approaching a discharge outlet 27 at the end of each nozzle. Each outlet 27 is offset to the side of the nozzle closest to the other nozzle, and is surrounded by a boss 28 projecting from the end of the nozzle.

As best seen in FIG. 8, the outlet 27 is offset within the boss 28 such that it is adjacent to the wall of the boss which is closest to the opposite nozzle. As the liquid is discharged, it will be in contact with this wall of the boss which will produce the deflection effect referred to above.

For the stability of the structure, a web 29 links the two nozzles.

As shown in FIG. 9, the cap 23 which is a push fit into the bottle 20 is provided with a pair of bosses 30 which fit within bosses 28, so that both outlets 27 are sealed simply by pushing the cap into place.

1. A bottle for dispensing two liquids, the bottle comprising two reservoirs, one for each liquid, a nozzle through which the liquids are dispensed from the bottle, a passageway from each reservoir leading out of the nozzle, and a deflector plate between the two passageways and projecting from the end of a nozzle in a direction substantially parallel to the direction of flow from the nozzles thereby causing the liquid leaving one passageway to be deflected towards the liquid leaving the other passageway so that the two liquids first mix once they have passed the deflector plate.

2. A bottle according to claim 1, wherein the passageways are arranged in a side-by-side relationship.

3. A bottle according to claim 1, wherein a single deflector plate is arranged to deflect the liquid from both passageways.

4. A bottle according to claim 1, wherein only one passageway is provided with the deflector plate.

5. A bottle according to claim 1, wherein each passageway has its own deflector plate.

6. A bottle according to claim 1, wherein the free end of the deflector plate is tapered in the direction of flow.

7. A bottle according to claim 1, wherein the two passageways are substantially parallel in the nozzle.

8. A bottle according to claim 1, wherein the nozzle is angled in respect to a main axis of the bottle.

9. A bottle according to claim 1, containing two liquids having a viscosity of less than 1000 Cps.

10. A bottle according to claim 1 containing two liquids which will mix to form a detergent.

11. A nozzle through which two liquids are dispensed, the nozzle being provided with two passageways and a deflector plate in the nozzle between the two passageways and projecting from the end of the nozzle thereby causing at least one of the liquids leaving the passageways to be deflected towards the other so that the two liquids first mix once they have passed the deflector plate.

12. A bottle according to claim 9 containing two liquids having a viscosity of less than 500 Cps.
